(19) United States
(12) Patent Application Publication
(10) Pub. No.: US 2016/0337356 A1
(43) Pub. Date: Nov. 17, 2016

(54) DEPLOYMENT TEMPLATES WITH EMBEDDED PERMISSIONS

(71) Applicant: RightScale Inc., Santa Barbara, CA (US)

(72) Inventors: Raphael George Jacques Simon, Santa Barbara, CA (US); Anthony Spataro, Santa Barbara, CA (US)

(73) Assignee: RightScale Inc.

(21) Appl. No.: 14/712,487

(22) Filed: May 14, 2015

(51) Int. Cl. H04L 29/06

(52) U.S. Cl. CPC H04L 63/10

(57) ABSTRACT

Systems and methods for authorizing execution of actionable data by receiving a request to enable third-party use of the actionable data, the request authorized by an account with a first set of permissions, and recording the first set of permissions in association with the actionable data, receiving a request to execute the actionable data, the request authorized by an account with a second set of permissions, determining that a unified set of permissions inclusive of the first set of permissions and the second set of permissions is sufficient to authorize execution of the actionable data, and authorizing execution of the actionable data responsive to the determination. Presented as an example of actionable data is a deployment template for provisioning resources in a cloud computing environment. The disclosed systems and methods are equally applicable to other forms and contexts of actionable data.

### BACKGROUND

Cloud computing enables an end-user to remotely use computing resources, without requiring the end-user to directly control or manage the underlying hardware for the computing resources. For example, an end-user can remotely instantiate virtual servers running software specified by the end-user. The end-user can be, for example, a customer of a third-party cloud computing service provider, where the end-user has no ownership of the underlying hardware. These cloud computing service providers frequently provide additional special-purpose servers or services for interactive use by the customer or the customer's software running on the virtual servers. Examples of cloud computing service providers include, for example, Amazon.com, Inc. (e.g., Amazon Web Services), Rackspace Hosting, Inc. (e.g., Rackspace Cloud), Google Inc. (e.g. Google Compute Engine), and Microsoft Corp. (e.g., Windows Azure). Cloud computing service providers may provide multi-tenant clouds, or may provide dedicated infrastructure to a single tenant. Cloud computing service providers may also be referred to as hosts, host providers, or service-host providers.

### SUMMARY

Aspects and embodiments of the present disclosure are directed to systems and methods for authorizing execution of actionable data. Presented as an example of actionable data is a deployment template for provisioning resources in a cloud computing environment. The disclosed systems and methods are equally applicable to other forms and contexts of actionable data.

At least one aspect of the disclosure is directed to a method that includes receiving a publication request to enable third-party use of actionable data, the publication request authorized by a first account with a first set of permissions and recording the first set of permissions in association with the actionable data. The method includes receiving a use request to execute the actionable data, the use request authorized by a second account with a second set of permissions, wherein the second set of permissions is different from the first set of permissions; determining that a unified set of permissions inclusive of the first set of permissions and the second set of permissions is sufficient to authorize execution of the actionable data; and authorizing execution of the actionable data responsive to the determination that the unified set of permissions is sufficient.

In some implementations, the first set of permissions or the second set of permissions is insufficient, alone, to authorize execution of the actionable data; it is the combination of the sets of permissions that is determined to be sufficient.

The method may further include receiving the actionable data from a third account with a third set of permissions, wherein the unified set of permissions is inclusive of the third set of permissions. In some implementations, the third set of permissions is insufficient to authorize execution of the actionable data.

The method may further include receiving the actionable data from a third account with a third set of permissions, identifying a sub-set of the third set of permissions sufficient to authorize execution of the actionable data, and recording the sub-set of the third set of permissions in association with the actionable data, wherein the unified set of permissions is inclusive of the recorded sub-set of the third set of permissions.

In some implementations of the method, the actionable data is a custom deployment template that includes configuration information for a plurality of resources in one or more computing clouds. The method may include execution of the actionable data by configuring at least one resource in the plurality of resources based on the configuration information, where configuring the at least one resource requires a sufficient authorization satisfied by the unified set of permissions. The method may include issuing commands to at least one computing cloud interface based on the configuration information using a credential associated with a source account. The method may further include receiving the actionable data from a third account, where the source account is either the first account or the third account.

At least one aspect is directed to a method that includes receiving, from a first requestor, a dissemination request to disseminate a custom deployment template, wherein the custom deployment template includes instructions for configuring a plurality of resources in one or more computing clouds, and wherein configuring at least one resource in the plurality of resources requires a sufficient authorization, and recording, in association with the custom deployment template, authorization information indicating that the first requestor has the sufficient authorization. The method includes receiving, from a second requestor, a launch request to launch the custom deployment template; determining that the launch request is authorized based on the authorization information recorded in association with the custom deployment template; and executing the launch request responsive to the determination, wherein executing the launch request causes configuration of the at least one resource.

In some implementations of the method, the method includes determining that the second requestor lacks sufficient authorization to instantiate the at least one resource, and temporarily granting the second requestor the sufficient authorization based on the recorded authorization information. In some instances, the dissemination request is received prior to, and the launch request is received subsequent to, revocation of the sufficient authorization from the first requestor.

Configuring the at least one resource may include one or more of: provisioning the at least one resource, instantiating the at least one resource, modifying a parameter of the at least one resource, and terminating the at least one resource.

In some implementations, the actionable data is a custom deployment template that includes instructions for configuring a plurality of resources in one or more computing clouds. In some implementations, the request to enable third-party use of the actionable data is a request to disseminate the actionable data. In some implementations, the request to enable third-party use of the actionable data is a request to publish the actionable data to a catalog.

At least one aspect of the disclosure is directed to computer-readable media storing instructions that, when executed by one or more computing processors, cause the one or more computing processors to receive a publication request to enable third-party use of actionable data, the publication request authorized by a first account with a first set of permissions and to record the first set of permissions in association with the actionable data. The media further stores instructions that, when executed by one or more computing processors, cause the one or more computing processors to receive a use request to execute the actionable data, the use request authorized by a second account with a second set of permissions, wherein the second set of permissions is different from the first set of permissions; to determine that a unified set of permissions inclusive of the first set of permissions and the second set of permissions is sufficient to authorize execution of the actionable data; and to authorize execution of the actionable data responsive to the determination that the unified set of permissions is sufficient. In some implementations, the first set of permissions or the second set of permissions is insufficient, alone, to authorize execution of the actionable data; it is the combination of the sets of permissions that is determined to be sufficient. In some implementations, the actionable data is a custom deployment template that includes instructions for configuring a plurality of resources in one or more computing clouds. In some implementations, the request to enable third-party use of the actionable data is a request to disseminate the actionable data. In some implementations, the request to enable third-party use of the actionable data is a request to publish the actionable data to a catalog.

At least one aspect of the disclosure is directed to a system that includes a data storage device with computer-readable memory configured to store permission information in association with actionable data information. The system includes a computing device comprising computer-readable memory configured to store computer-executable instructions and at least one processor configured to execute the stored instructions, wherein the instructions, when executed, cause the processor to receive a publication request to enable third-party use of actionable data, the publication request authorized by a first account with a first set of permissions, and to record, in the data storage device, the first set of permissions in association with the actionable data. The instructions, when executed, further cause the processor to receive a use request to execute the actionable data, the use request authorized by a second account with a second set of permissions, wherein the second set of permissions is different from the first set of permissions; to determine that a unified set of permissions inclusive of the first set of permissions and the second set of permissions is sufficient to authorize execution of the actionable data; and to authorize execution of the actionable data responsive to the determination that the unified set of permissions is sufficient.

In some implementations, the first set of permissions or the second set of permissions is insufficient, alone, to authorize execution of the actionable data; it is the combination of the sets of permissions that is determined to be sufficient. In some implementations, the actionable data is a custom deployment template that includes instructions for configuring a plurality of resources in one or more computing clouds. In some implementations, the request to enable third-party use of the actionable data is a request to disseminate the actionable data. In some implementations, the request to enable third-party use of the actionable data is a request to publish the actionable data to a catalog.

In some implementations of the system, the instructions, when executed, further cause the processor to receive the actionable data from a third account with a third set of permissions, wherein the unified set of permissions is inclusive of the third set of permissions. In some implementations, the third set of permissions is insufficient to authorize execution of the actionable data.

In some implementations of the system, the instructions, when executed, further cause the processor to receive the actionable data from a third account with a third set of permissions, identify a sub-set of the third set of permissions sufficient to authorize execution of the actionable data, and record, in the data storage device, the sub-set of the third set of permissions in association with the actionable data, wherein the unified set of permissions is inclusive of the recorded sub-set of the third set of permissions.

In some implementations of the system, the actionable data is a custom deployment template that includes configuration information for a plurality of resources in one or more computing clouds. In some implementations of the system, the instructions, when executed, further cause the processor to execute the actionable data by configuring at least one resource in the plurality of resources based on the configuration information, where configuring the at least one resource requires a sufficient authorization satisfied by the unified set of permissions. In some implementations of the system, the instructions, when executed, further cause the processor to issue commands to at least one computing cloud interface based on the configuration information using a credential associated with a source account. The system may receive the actionable data from a third account, where the source account is either the first account or the third account.

In some implementations of the system, the instructions, when executed, further cause the processor to receive, from a first requestor, a dissemination request to disseminate a custom deployment template, wherein the custom deployment template includes instructions for configuring a plurality of resources in one or more computing clouds, and wherein configuring at least one resource in the plurality of resources requires a sufficient authorization, and recording, in association with the custom deployment template, authorization information indicating that the first requestor has the sufficient authorization. In some implementations of the system, the instructions, when executed, further cause the processor to receive, from a second requestor, a launch request to launch the custom deployment template; determine that the launch request is authorized based on the authorization information recorded in association with the custom deployment template; and execute the launch request responsive to the determination, wherein executing the launch request causes configuration of the at least one resource.

In some implementations of the system, the instructions, when executed, further cause the processor to determine that the second requestor lacks sufficient authorization to instantiate the at least one resource, and temporarily grant the second requestor the sufficient authorization based on the authorization information recorded in the data storage device. In some instances, the dissemination request is received by the system prior to, and the launch request is received subsequent to, revocation of the sufficient authorization from the first requestor.

Configuring the at least one resource may include one or more of: provisioning the at least one resource, instantiating the at least one resource, modifying a parameter of the at least one resource, and terminating the at least one resource.

In some implementations, the actionable data is a custom deployment template that includes instructions for configuring a plurality of resources in one or more computing clouds. In some implementations, the request to enable third-party use of the actionable data is a request to disseminate the actionable data. In some implementations, the request to enable third-party use of the actionable data is a request to publish the actionable data to a catalog.

### BRIEF DESCRIPTION OF THE DRAWINGS

The above and related objects, features, and advantages of the present disclosure will be more fully understood by reference to the following detailed description, when taken in conjunction with the following figures, wherein:

FIG. 1 is a block diagram illustrating an example network environment including a cloud management service;

FIG. 2 is a flowchart for an example method of authorizing an action;

FIG. 3 is a flowchart for an example method of provisioning a custom deployment template based on a composite set of permissions;

FIG. 4A is a block diagram illustrating an example database and grouping permissions into a unified set of provisioning permissions;

FIG. 4B is a block diagram illustrating an alternative template table with embedded permissions; and

FIG. 5 is a block diagram of a computer device suitable for use in some implementations.

The accompanying drawings are not intended to be drawn to scale. Like reference numbers and designations in the various drawings indicate like elements. For purposes of clarity, not every component may be labeled in every drawing.

### DETAILED DESCRIPTION

As described in detail herein, cloud computing resources can be provisioned based on a deployment template. A template designer creates a deployment template and makes it available to others, e.g., by publishing it in an organization-wide catalog. In some instances, someone other than the designer is responsible for publishing deployment templates to the catalog. For example, the publisher may be a supervisor or a person responsible for quality assurance. A template consumer may then select a deployment template from the catalog and request provisioning of it. Provisioning the deployment template can include establishing or creating resources in one or more computing clouds, configuring resources in the one or more computing clouds, launching applications in the computing one or more computing clouds, and any other tasks detailed by the template. Each of these tasks or activities may require particular permissions. Permissions include, for example, privileges, authorizations, access rights, and/or any other access control. As described herein, the permissions used to provision a template are a unified set of permissions that include permissions held by the template source (e.g., the designer and/or the publisher) and permissions held by the template user requesting the provisioning (the “provisioner”). This security model eliminates the need for the provisioner to hold the sensitive permissions needed for the tasks implicated by the deployment template.

Typically, designers are expected to be more advanced and/or more trusted than the consumer/provisioners who select deployment templates form the catalog. For example, the designer may be a professional software engineer responsible for creating specific purpose application deployment templates that are then provisioned by marketing specialists to set-up marketing micro-sites. For example, an application template may include instructions to open certain firewall ports so the application can be accessed. In the example of a marketing micro-site, ports 80 (http) and 443 (https) need to be opened so the public can access the site. However, it is a security risk to let everyone in the organization have the ability to open these ports to arbitrary servers/services. As a result, it is often undesirable to give the end user provisioners blanket permissions that may be required to launch resources in the one or more computing clouds. Accordingly, the provisioners are granted permissions only in the limited context of an application deployment template obtained from an approved catalog.

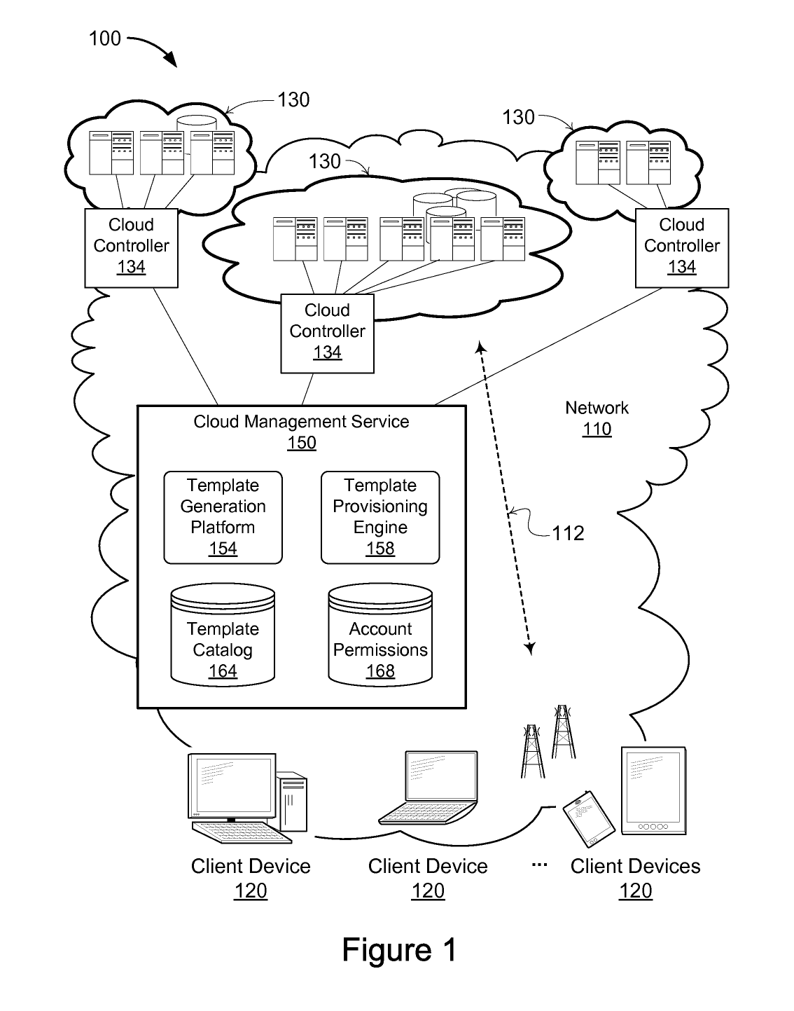

FIG. 1 is a block diagram illustrating an example network environment 100 including a cloud management service 150. In broad overview, FIG. 1 includes a network 110 facilitating communication 112 between client devices 120 and computing clouds 130. Each computing cloud 130 is illustrated with a cloud controller 134. A cloud management service 150 interacts with the cloud controllers 134 to provision resources within the respective clouds 130. The cloud management service 150 includes a template generation platform 154 and a template catalog 165. Designers and publishers can use the template generation platform 154 to create deployment templates and insert them into the template catalog 165. The cloud management service 150 also includes a template provisioning engine 158 and a library of account permissions 168.

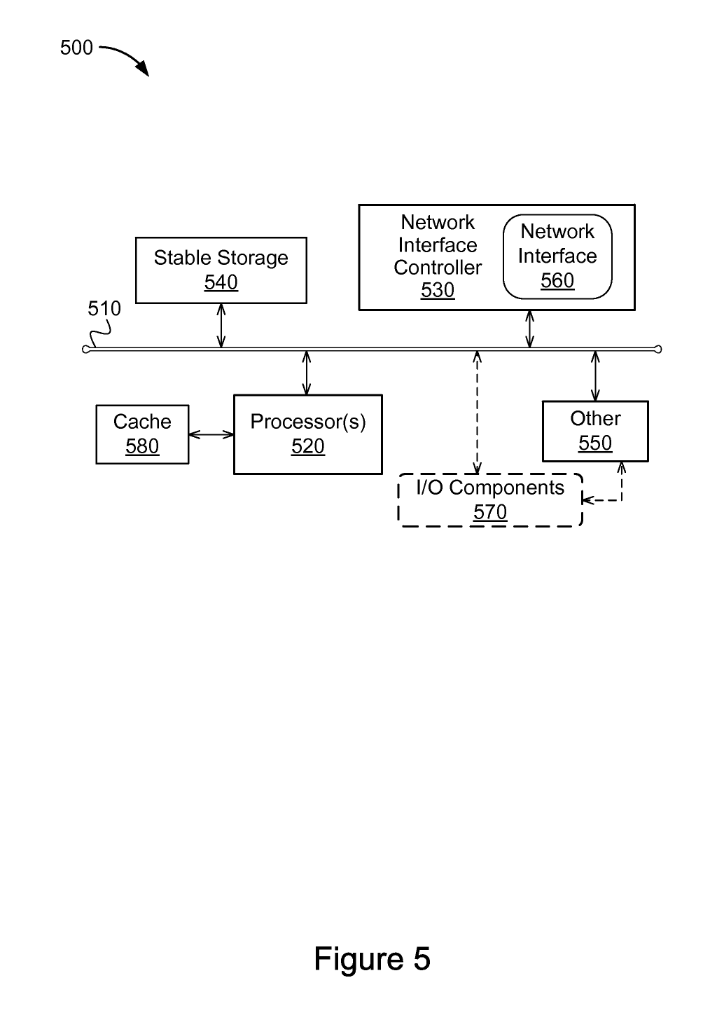

Referring to FIG. 1 in more detail, computing clouds 130 include any configuration of computing devices to provide cloud computing resources. For example, the National Institute of Standards and Technology (“NIST”) defines a computing cloud as an infrastructure that enables “ubiquitous, convenient, on-demand network access to a shared pool of configurable computing resources (e.g., networks, servers, storage, applications, and services) that can be rapidly provisioned and released with minimal management effort or service provider interaction.” (NIST Pub. 800-145 at page 3 (September 2011)). The NIST definition, however, is not limiting; accordingly, computing infrastructures may constitute a computing cloud without strict compliance to an NIST definition. One example of a computing cloud 130 is a multi-tenant cloud hosted by a third-party service provider such as, for example, Amazon.com, Inc. (e.g., Amazon Web Services), Rackspace Hosting, Inc. (e.g., Rackspace Cloud), Google Inc. (e.g. Google Compute Engine), or Microsoft Corp. (e.g., Windows Azure). In some implementations, the computing cloud 130 may be single-tenant and/or hosted within an organization or corporate entity that also provides the cloud management service 150. The computing clouds 130 may be private or public. The computing clouds 130 provide resources such as servers (physical or virtualized) and services that generally relate to, and interact with, the servers. For example, Amazon Elastic MapReduce (Amazon EMR) is a web service that enables Amazon's customers to process large amounts of data. “[EMR] utilizes a hosted Hadoop framework running on the web-scale infrastructure of Amazon Elastic Compute Cloud (Amazon EC2) and Amazon Simple Storage Service (Amazon S3).” (http://aws.amazon.com/elasticmapreduce/). In some implementations, the cloud management service 150 facilitates a deployment across multiple computing clouds 130. In such implementations, some of the participating computing clouds 130 may be private, while other participating computing clouds 130 may be public. Each participating computing cloud 130 may use its own authentication scheme for controlling provisioning and management of cloud-provided resources. For example, distinct credentials may be required for administration of each computing cloud 130. FIG. 5, described below, illustrates an example computing device 500 suitable for use as a server participating within the infrastructure of a computing cloud 130.

Each computing cloud 130 includes one or more cloud controllers 134. The cloud controller 134 is an administrative interface for provisioning, configuring, maintaining, and otherwise managing a respective computing cloud 130. For example, the cloud controller 134 may enable a customer of the cloud provider to instantiate and use one or more virtual servers in various different configurations matching the particular needs of the customer. The customer may configure, use, or manipulate these services and servers as needed. A customer may be an individual or an organization, e.g., a corporate entity. Host providers may characterize a customer as an account, such that the servers and services for a customer are scoped within a single account with one or more users authorized to access the account using a user-specific credential, e.g., using some combination of an email address, a user ID, an account ID, an account or user-specific password, and/or an encrypted or signed certificate. A user may provision, configure, or use the virtual servers and services hosted by the computing cloud 130, e.g., by issuing requests to the cloud controller 134. For example, the user may submit a request to a cloud controller 134 using a protocol such as HTTP or HTTPS. The cloud controller 134 authenticates the request based on the access credentials associated with the request. For example, in some instances, the request is accompanied by a credential or an authentication token. In some instances, the request is submitted during an authenticated session. In some implementations, cloud management service 150 provides the customer with a token or access entity credentials enabling the customer's client device 120 to communicate directly 112 with the cloud controller 134 or a service provisioned in a computing cloud 130. In some implementations, information for each user or customer account is stored by the cloud management service 150 in a library of account permissions 168. The library of account permissions 168 may include, for example, account description information, account identifiers such as a user name, a flag indicating whether the account is active or disabled, and a set of permissions, access rights, and/or credentials for use by the cloud management service 150 on behalf of the respective account in interactions with one or more cloud controllers 134.

In some implementations, users interact with the cloud management service 150 as an intermediary between the user and the cloud controllers 134 for the respective computing clouds 130. In some embodiments, the cloud management service 150 presents an API (Application Programming Interface) via the network 110 to a client device 120. In some embodiments, the interface presented by the cloud management service 150 is a web interface or website. In some embodiments, the client device 120 executes software configured to communicate with the cloud management service 150.

Generally, the cloud management service 150 is capable of interacting with a cloud controller 134 for a computing cloud 130 to provision and manage cloud-based resources, e.g., to instantiate cloud-based services and virtual servers hosted by the computing cloud 130. The interaction may be in the form of a request from the cloud management service 150 to the cloud controller 134 or to a service operated within the computing cloud 130. The interaction may be in the form of steps performed by the cloud management service 150. In some embodiments, the cloud management service 150 is further capable of modifying an instantiated cloud-based service or virtual server, e.g., pausing a service or updating a virtual server. In some embodiments, the cloud management service 150 converts between a standardized instruction set and instruction sets tailored to each computing cloud 130.

The cloud management service 150 includes a template generation platform 154 and a template catalog 165. Designers and publishers can use the template generation platform 154 to create deployment templates and insert them into the template catalog 165. In some implementations, the template generation platform 154 provides an interface for creating and testing deployment templates. In some implementations, the template generation platform 154 is an interface for inserting a template into a template catalog 164. A deployment template specifies one or more resources to be provisioned. In some instances, a deployment template specifies one or more relationships between resources. For example, a deployment template can specify a resource, e.g., an HTTP host, with dependencies on additional resources, e.g., a dependency on a back-end data server. The deployment template may specify one or more cloud computing host providers, parameters for selecting one or more cloud computing host providers, or conditional logic for identifying one or more cloud computing host providers. In some implementations, the deployment template includes instructions for configuring resources. In some implementations, the deployment template includes instructions for sequencing instantiation of resources. In some implementations, the deployment template includes conditional instructions.

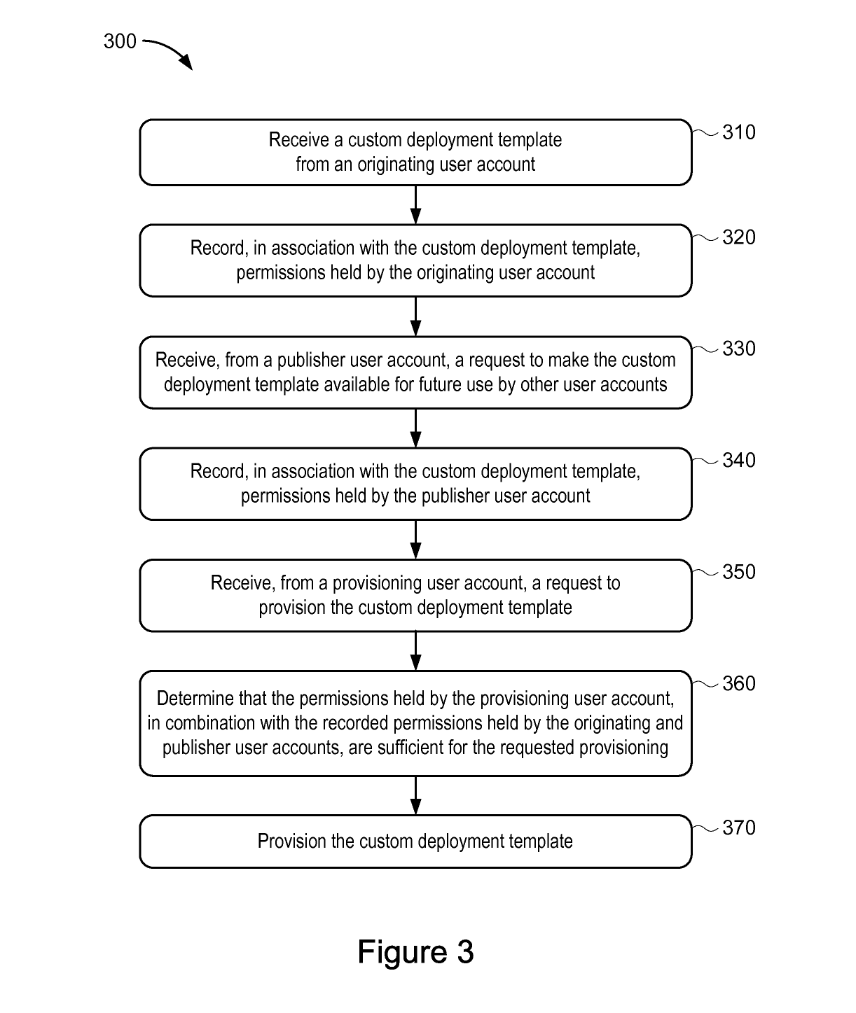

The cloud management service 150 includes a template provisioning engine 158 for use in launching, using, executing, activating, or otherwise provisioning a template from the template catalog 164. FIG. 3, described below, is a flowchart for an example method 300 of provisioning a template from a catalog, e.g., the template catalog 164, using permissions recorded in association with the templates. In some implementations, the template provisioning engine 158 implements the method 300. In some implementations, the template provisioning provides an interface, e.g., an API, a web interface, or a custom utility, for use by a user of a client device 120, through which the user can request provisioning of a template.

The template catalog 165 and library of account permissions 168 may each be implemented using one or more data storage devices. The data storage devices may be any memory device suitable for storing computer readable data. The data storage devices may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or Blu-Ray® discs). Example implementations of suitable data storage devices include storage area networks (“SAN”), network attached storage (“NAS”), and redundant storage arrays. Data for the template catalog 165 and/or the library of account permissions 168 may be recorded as data files in a file system or as data in a knowledge base, object database, relational database, or other data organizing structure. In some implementations, all or portions of the data is recorded in an encrypted form.

The network 110 facilitates communication 112 between client devices 120 and computing clouds 130. Examples of communication networks include a local area network (“LAN”), a wide area network (“WAN”), an inter-network (e.g., the Internet), and peer-to-peer networks (e.g., ad hoc peer-to-peer networks). The network 110 may be composed of multiple connected sub-networks or autonomous networks. The network 110 can be a corporate intranet, a metropolitan area network (MAN), or a virtualized network. In some implementations, the network 110, or portions of the network 110, adheres to the multi-layer Open System Interconnection (“OSI”) networking framework (“OSI Model”). Any type and/or form of data network and/or communication network can be used for the network 110. It can be public, private, or a combination of public and private networks. In general, the network 110 is used to convey information between computing devices, e.g., between the patient device 124, an interaction platform 136, and a care provider device 128.

Client devices 120 include, but are not limited to, computing devices used by consumers of the functionality provided by the computing clouds 130. The client devices 120 interact 112 with the computing clouds 130. An end-user may, for example, access a web page hosted by a cloud server, store data at a cloud-based storage, or benefit from infrastructure provided by a computing cloud 130. In some implementations, a user of a client device 120 may interact with a cloud controller 134 to establish or modify a resource deployment hosted by a computing cloud 130. In some implementations, a user of a client device 120 may interact with the cloud management service 150 to establish or modify a resource deployment hosted by a computing cloud 130. In some implementations, a user of a client device 120 may interact with the cloud management service 150 to design, publish, and/or provision a deployment template. FIG. 5, described below, illustrates an example computing device 500 suitable for use as a client device 120.

The cloud management service 150 implements a composite security model for authorizing provisioning of deployment templates. As users interact with the cloud management service 150 to design, publish, and provision templates, the cloud management service 150 captures permissions associated with each user. When the provisioning-user (“provisioner”) requests provisioning of a deployment template, the captured permissions are used to determine whether the request can be authorized. That is, permissions are recorded before they are needed for the provisioning, and the combination of recorded permissions, as well as permissions associated with provisioner, are used to authorize the provisioning request.

In some implementations, a design or publishing user (a source user) grants specific authorizations or permissions to a template prior to its use by a provisioner. In some such implementations, one or more source users authorize or grant use of specific credentials by a subsequent provisioning user. In some implementations, a source user embeds permissions in the template, or in a record in association with the template. In some implementations, a source users grant remains effective even if the source user ceases to have the granted permissions. For example, it may be that a designer or publisher of a template for an organization leaves the organization prior to a use of the template. Although the designer or publisher has departed from the organization, and no longer has the requisite permissions, the permissions continue to exist as granted to the template. A provisioner authorized to use the template will also be able to use the permissions associated with the template.

In some implementations, the template generation platform 154 conducts an authorization check at design-time to determine if the designer has sufficient authorization to provision a template. If so, a flag is recorded with the template, e.g., in the template catalog 164, that identifies the template as pre-authorized regardless of other permissions. Likewise, in some implementations, the template generation platform 154 conducts an authorization check at publication-time to determine if the publisher, or the publisher in combination with the designer, has sufficient authorization to provision a template. If so, the flag is recorded with the template to identify the template as pre-authorized regardless of other permissions. In some such implementations, the template generation platform 154 validates the permissions (at design-time and/or publication-time) and stores a signed certificate or token in association with the template. The signed certificate or token is then used by the template provisioning engine 158 to verify the flag indicating that the template has been pre-authorized.

In some implementations, the composite security model is used to authorize execution of any actionable data, e.g., deployment templates, executable software instructions, scripts, or any other such data. In some implementations, the actionable data is stored as one or more files in a file system. In some implementations, the actionable data is packaged together as a set of files or modules. In some implementations, the actionable data is referenced in a database. In some implementations, the actionable data is stored in a third-party repository.

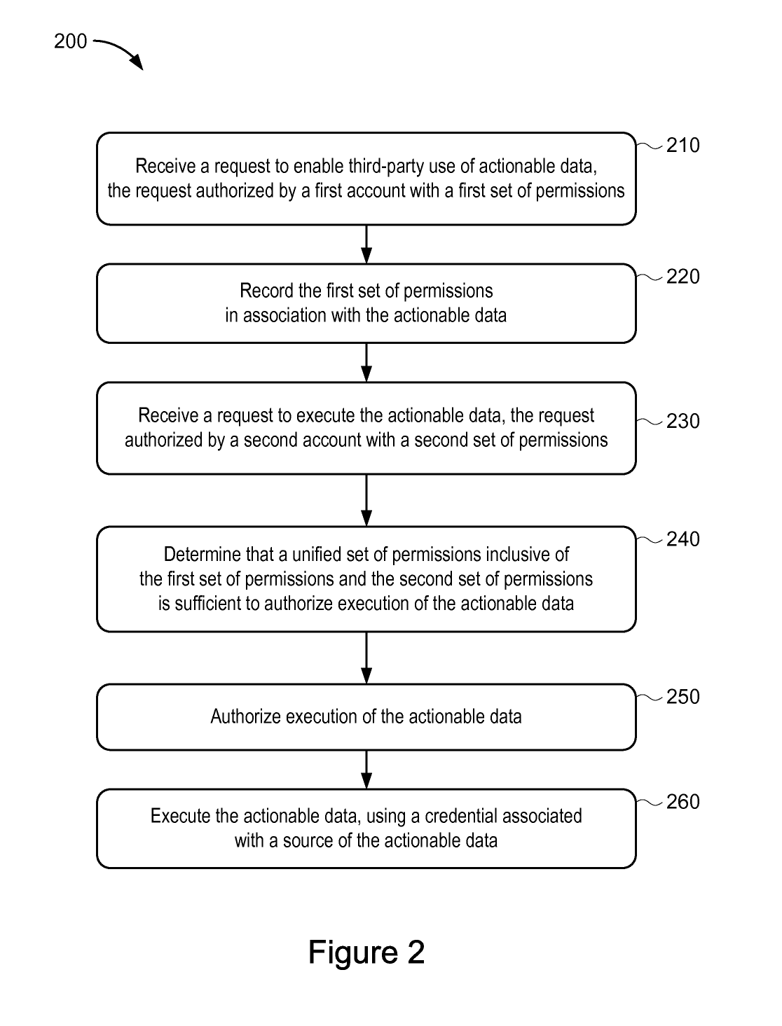

FIG. 2 is a flowchart for an example method 200 of authorizing an action. In a broad overview of the method 200, the cloud management service 150 receives a request to enable third-party use of actionable data, where the request is authorized by a first account with a first set of permissions (stage 210), and records the first set of permissions in association with the actionable data (stage 220). Later, the cloud management service 150 receives a request to execute the actionable data, the request authorized by a second account with a second set of permissions (stage 230). The cloud management service 150 determines whether a unified set of permissions inclusive of the first set of permissions and the second set of permissions is sufficient to authorize execution of the actionable data (stage 240). If it the unified set of permissions is insufficient, the request is denied. Otherwise, the cloud management service 150 authorizes execution of the actionable data (stage 250) and, in some implementations, executes the actionable data, e.g., using a credential associated with a source of the actionable data (stage 260).

Referring to FIG. 2 in more detail, the method 200 may begin with the cloud management service 150 receiving a request to enable third-party use of actionable data, the request authorized by a first account with a first set of permissions (stage 210). In general, the first account may be associated with an author of the actionable data, a designer, a team of designers, a creator, a publisher, or any other user role. In some implementations, the request is a request to publish the actionable data to a catalog. In some implementations, the request is a request to augment an action library. In some implementations, the request is accompanied by a credential. In some implementations, the cloud management service 150 receives the request and verifies that the request is both authentic and authorized.

The cloud management service 150 then records the first set of permissions in association with the actionable data (stage 220). In some implementations, the actionable data has been previously recorded in association with a set of permissions, e.g., an author's permission set. The cloud management service 150 records the first set of permission in combination with any existing permissions, i.e., as a union of the permission sets.

The cloud management service 150 then, subsequently, receives a request to execute the actionable data, the request authorized by a second account with a second set of permissions (stage 230). The second account may belong to a second user, different from the user of the first account. This second account might not have sufficient permissions to execute the actionable data absent authorization from the user of the first account. For example, the actionable data may be a script or executable code that requires permission to execute administrative-level instructions. The second account may have authorization to execute actionable data, but lack permission to execute these administrative-level instructions embedded in the actionable data.

The cloud management service 150 determines that a unified set of permissions inclusive of the first set of permissions and the second set of permissions is sufficient to authorize execution of the actionable data (stage 240). The cloud management service 150 identifies a unified set of permissions that includes the permissions recorded in association with the actionable data and the second set of permissions associated with the second account. The cloud management service 150 then verifies that this unified set of permissions is sufficient to fully execute the actionable data. In some implementations, the actionable data may include an embedded credential for use in executing one or more instructions included in the data. The cloud management service 150 may determine that a flag is set pre-authorizing use of the embedded credential by permitted users of the actionable data.

The cloud management service 150 authorizes execution of the actionable data (stage 250). In response to determining that the unified set of permissions is sufficient for execution of the actionable data, the cloud management service 150 permits the request to execute the actionable data to proceed.

In some implementations, executes the actionable data, e.g., using a credential associated with a source of the actionable data (stage 260). In some implementations, authorizing execution includes executing the actionable data. In some implementations, authorizing execution includes generating a signed token used by a third-party to authorize execution. In some implementations, authorizing execution includes using an embedded credential to access an computing resource (e.g., a cloud controller or a cloud-hosted server) and passing the actionable data to the computing resource for execution.

FIG. 3 is a flowchart for an example method 300 of provisioning a custom deployment template based on a composite set of permissions. In a broad overview of the method 300, the cloud management service 150 receives a custom deployment template from a first user account (stage 310) and records, in association with the custom deployment template, permissions held by the first user account (stage 320). The cloud management service 150 receives, from a second user account, a request to make the custom deployment template available for future use by other user accounts (stage 330) and records, in association with the custom deployment template, permissions held by the second user account (stage 340). The cloud management service 150 then receives, from a third user account, a request to provision the custom deployment template (stage 350) and determines whether the permissions held by the third user account, in combination with the recorded permissions held by the first and second user accounts, are sufficient for the requested provisioning (stage 360). If it the unified set of permissions is insufficient, the request is denied. Otherwise, the cloud management service 150 proceeds with provisioning the custom deployment template (stage 370).

Referring to FIG. 3 in more detail, the method 300 begins with the cloud management service 150 receiving a custom deployment template from a first user account (stage 310). For example, a first user may be an author, creator, or designer (collectively referred to as the “designer” for simplicity) of the custom deployment template. The first user may submit the request, for example, using a template generation platform 154. The request may be to insert the template into a template catalog 164 or into a pre-publication database. In some implementations, the template is inserted into the template catalog 164 with a pre-publication flag set to prevent a template provisioning engine 158 from using the template outside of test environments.

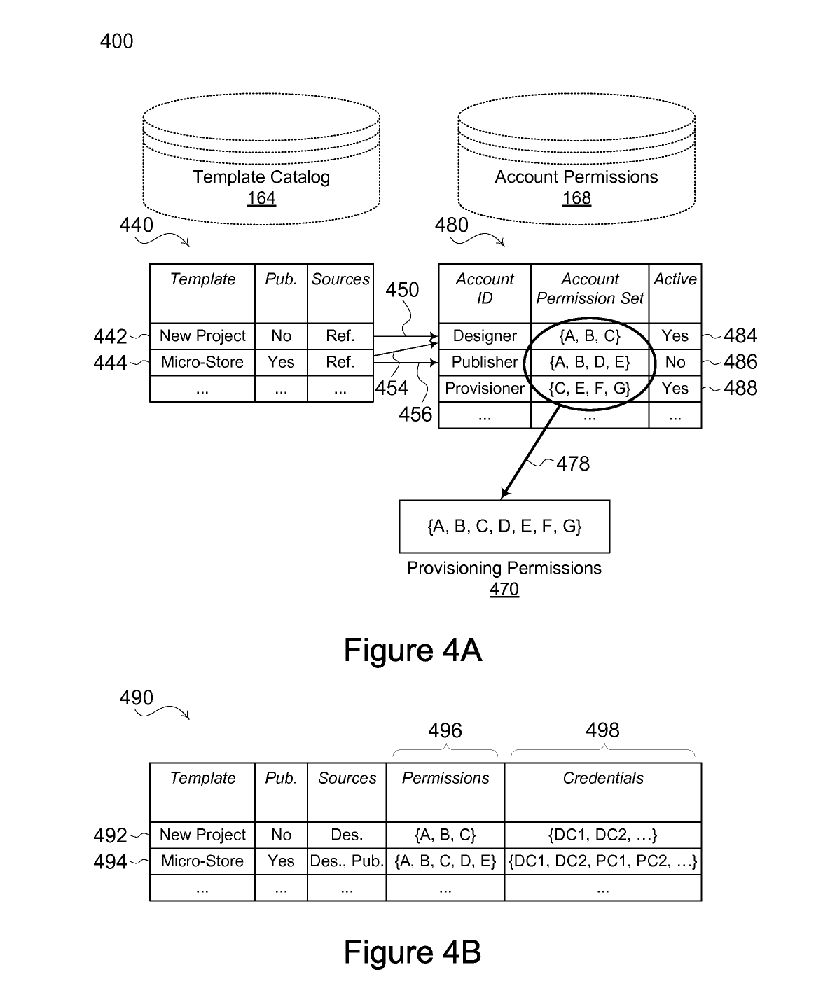

Responsive to receipt of the custom deployment template, the cloud management service 150 records, in association with the custom deployment template, permissions held by the first user account (stage 320). FIGS. 4A and 4B, described below, illustrate examples of recorded permissions. In some implementations, credentials associated with the first user account are recorded in association with the custom deployment template. In some implementations, the cloud management service 150 sets a pre-authorization flag indicating that the first user has sufficient authorization to provision the custom deployment template and/or to grant other users authorization to provision the custom deployment template.

The cloud management service 150 subsequently receives, from a second user account, a request to make the custom deployment template available for future use by other user accounts (stage 330). For example, a second user may be a supervisor or quality assurance professional. The request to make the template available to others may be a request to disseminate the template, e.g., by publishing it to a template catalog 164 or by setting a flag in the template catalog 164 that enables a template provisioning engine 158 to use the template. The second user (referred to as the “publisher” for simplicity) may be the same as the first user, e.g., where the designer self-publishes, or may be another user, such as another designer, a supervisor of the designer, or a decision maker in another department such as quality assurance.

Responsive to receipt of the request to make the custom deployment template available for future use by other user accounts, the cloud management service 150 records, in association with the custom deployment template, permissions held by the second user account (stage 340). FIGS. 4A and 4B, described below, illustrate examples of recorded permissions. In some implementations, credentials associated with the second user account are recorded in association with the custom deployment template. In some implementations, the cloud management service 150 sets a pre-authorization flag indicating that the second user has sufficient authorization to provision the custom deployment template and/or to grant other users authorization to provision the custom deployment template. In some implementations, the cloud management service 150 sets a pre-authorization flag indicating that the combination of permissions held by the first user and the second user is sufficient to authorize provisioning of the custom deployment template and/or to grant other users authorization to provision the custom deployment template.

Still referring to FIG. 3, the cloud management service 150 receives, from a third user account, a request to provision the custom deployment template (stage 350). For example, a provisioning-user (“provisioner”) may select the template from a template catalog 164 using a template provisioning engine 158.

The cloud management service 150 determines whether the permissions held by the third user account, in combination with the recorded permissions held by the first and second user accounts, are sufficient for the requested provisioning (stage 360). If it the unified set of permissions is insufficient, the request is denied. Otherwise, the cloud management service 150 proceeds with provisioning the custom deployment template (stage 370). In some implementations, the cloud management service 150 first determines that the permissions held by the third user account are insufficient. In some implementations, the cloud management service 150 does not verify whether the permissions held by the third user account are sufficient, and proceeds, instead, directly to verifying a unified set of permissions that includes those permissions held by the provisioner and also includes those permissions recorded at stages 320 and 340. In some implementations, the cloud management service 150 proceeds to stage 370 based on whether a pre-authorization flag is set in association with the template, indicating that the source account(s) held sufficient permissions to authorized provisioning.

The cloud management service 150 provisions the custom deployment template (stage 370). In some implementations, provisioning the template requires use of a credential, e.g., a credential for authorized access to resources hosted in computing cloud 130. The provisioner, i.e., the third user, may lack the proper credential or rights to the proper credential. However, in some implementations, the cloud management service 150 grants the provisioner temporary rights to use a credential associate with a source of the template. In some implementations, the cloud management service 150 obtains a new credential for temporary use in provisioning the template. The authorization for the provisioner to use these credentials is premised on the unified set of permissions from the template source(s) and the provisioner.

FIG. 4A is a block diagram illustrating an example database 400 and grouping permissions into a unified set of provisioning permissions 470. The cloud management service 150 maintains information for each template and each account. For example, as illustrated in FIGS. 1 and 4, in some implementations, the cloud management service 150 includes a template catalog 164 and a library of account permissions 168. In some implementations, the template catalog 164 stores template information, e.g., as a template information table 440. In some implementations, the library of account permissions 168 stores account permission information, e.g., as an account information table 480. As shown in FIG. 4A, the example template information table 440 includes entries for each recorded deployment template (e.g., “New Project” 442 and “Micro-Store” 444), and the example account information table 480 includes entries for each user account (e.g., a “Designer” account entry 484, a “Publisher” account entry 486, and a “Provisioner” account entry 488). In some implementations, the information represented in these tables 440 and 480 is stored in a relational database 400.

Referring still to the example illustrated in FIG. 4A, each of the template entries 442 and 444 includes information regarding respective sources of the template. For example, the entry 442 for a template “New Project” includes a reference 450 to an account entry 484 as a source of the “New Project” template, i.e., the account entry 484 for user “Designer.” Each of the account entries 484, 486, and 488 includes information regarding the set of permissions associated with the respective entry. When a user (e.g., “Provisioner”) attempts to provision a template (e.g., “Micro-Store”), the cloud management service 150 identifies an entry 444 in the template information table 440 corresponding to the template to be provisioned (i.e., “Micro-Store”) and identifies, from the entry 444, a set of permissions corresponding to the template's source. For example, the cloud management service 150 uses information in the template entry 444 referencing 454 and 456 the account entries 486 and 488 for the sources of the template. In the example illustrated in FIG. 4A, the “Micro-Store” template was designed by a user “Designer” with permissions {A, B, C} (as shown in the illustrative account entry 484, referenced 454 by the template entry 444) and published by a user “Publisher” with permissions {A, B, D, E} (as shown in the illustrative account entry 486, referenced 456 by the template entry 444). Accordingly, a unified set of permissions corresponding to the template's source is {A, B, C, D, E}. The cloud management service 150 combines this unified set of permissions with permissions associated with the user requesting provisioning (i.e., “Provisioner”) based on the entry 488 for that user. In the example illustrated in FIG. 4A, the Provisioner's permissions are {C, E, F, G}. The aforementioned permissions are unified 478 into a set of provisioning permissions 470. Then, if the unified set of provisioning permissions 470 is sufficient to provision the “Micro-Store” template (e.g., as may be determined in stage 360 of the method 300 illustrated in FIG. 3), the cloud management service 150 may proceed with provisioning.

In constructing the unified set of provisioning permissions 470, it is not necessary for a source account to be presently active. For example, a template may have been published for use within a company by a user who then subsequently left the company. In some implementations, the account permissions table 480 retains information for the departed user and flags the information as inactive (e.g., in the illustrative account entry 486 for user “Publisher,” the entry includes a “No” value for an “Active” field).

In some implementations, the tables 440 and 480 include more (or less) information than is shown in FIG. 4A. In some implementations, the entries 442, 444, 484, 486, and 488 include additional information not shown, such as an explicit set of permissions associated with a particular template and/or credentials associated with a template or an account. In some implementations, an alternative schema is used. For example, as shown in FIG. 4B, templates are stored in some implementations with an explicit set of permissions. In some implementations, there is no distinction between a publisher and a designer.

FIG. 4B is a block diagram illustrating an alternative template table 490 with embedded permissions 496. In some implementations, the template catalog 164 stores a template table 490 that includes a field for source permissions. As shown in FIG. 4B, the example template information table 490 includes entries for each recorded deployment template (e.g., “New Project” 492 and “Micro-Store” 494). When a designer creates a new template, the permissions 496 associated with the designer are recorded in association with the template. For example, the permissions may be copied into a source field or permissions field 496 for the template. Likewise, when a publisher makes the template available for other people to use, the permissions associated with the publisher are also recorded in association with the template. In some such implementations, the cloud management service 150 records the union of the existing source permissions and permissions associated with the publisher. In some implementations, one or more credentials 498 associated with respective source accounts are also recorded in association with the template by the cloud management service 150.

FIG. 5 is a block diagram of an example computing system 500 suitable for implementing the computing systems described herein, in accordance with one or more illustrative implementations. In broad overview, the computing system 500 includes at least one processor 520 for performing actions in accordance with instructions and one or more memory devices, such as stable storage 540 or cache 580, for storing instructions and data. The illustrated example computing system 500 includes one or more processors 520 in communication, via a bus 510, with stable storage 540, at least one network interface controller 530 with network interface port 560 for connection to a network (not shown), and other components 550, e.g., input/output (“I/O”) components 570. Generally, the processor(s) 520 will execute instructions received from memory. The processor(s) 520 illustrated incorporate, or are directly connected to, cache memory 580. In some instances, instructions are read from stable storage 540 into cache memory 580 and executed by the processor(s) 520 from cache memory 580.

In more detail, the processor(s) 520 may be any logic circuitry that processes instructions, e.g., instructions fetched from the stable storage 540 or cache 580. In many embodiments, the processor(s) 520 are microprocessor units or special purpose processors. The computing device 500 may be based on any processor, or set of processors, capable of operating as described herein. The processor(s) 520 may be single core or multi-core processor(s). The processor(s) 520 may be multiple distinct processors.

In some implementations, the computing device 500 controls the processor 520 through one or more abstraction layers. The processor 520 operates responsive to a set of instructions, e.g., machine code. The computing device 500 may include memory (e.g., a ROM) storing a firmware operating system such as BIOS. The firmware operating system, upon start-up, may initialize a software operating system responsible for controlling a flow of software instructions to the processor 520. The software operating system, and software embodied by the flow of instructions, can be run from a bootable medium, such as the stable storage 540, a bootable disc, or a USB device, or even via the network interface 560.

The stable storage 540 may be any memory device suitable for storing computer readable data. The stable storage 540 may be a device with fixed storage or a device for reading removable storage media. Examples include all forms of non-volatile memory, media and memory devices, semiconductor memory devices (e.g., EPROM, EEPROM, SDRAM, and flash memory devices), magnetic disks, magneto optical disks, and optical discs (e.g., CD ROM, DVD-ROM, or Blu-Ray® discs). A computing system 500 may have any number of stable storage devices 540.

The cache memory 580 is generally a form of computer memory placed in close proximity to the processor(s) 520 for fast read times. In some implementations, the cache memory 580 is part of, or on the same chip as, the processor(s) 520. In some implementations, there are multiple levels of cache 580, e.g., L2 and L3 cache layers.

The network interface controller 530 manages data exchanges via the network interface 560 (sometimes referred to as network interface ports). The network interface controller 530 handles the physical and data link layers of the OSI model for network communication. In some implementations, some of the network interface controller's tasks are handled by one or more of the processor(s) 520. In some implementations, the network interface controller 530 is part of a processor 520. In some implementations, a computing system 500 has multiple network interfaces 560 controlled by a single controller 530. In some implementations, a computing system 500 has multiple network interface controllers 530. In some implementations, each network interface 560 is a connection point for a physical network link (e.g., a cat-5 Ethernet link). In some implementations, the network interface controller 530 supports wireless network connections and an interface port 560 is a wireless (e.g., radio) receiver/transmitter (e.g., for any of the IEEE 802.11 protocols, near field communication “NFC”, Bluetooth, ANT, or any other wireless protocol). In some implementations, the network interface controller 530 implements one or more network protocols such as Ethernet. Generally, a computing device 500 exchanges data with other computing devices via physical or wireless links through a network interface 560. The network interface 560 may link directly to another device or to another device via an intermediary device, e.g., a network device such as a hub, a bridge, a switch, or a router, connecting the computing device 500 to a data network such as the Internet.

The computing system 500 may include, or provide interfaces for, one or more input or output (“I/O”) devices. Input devices include, without limitation, keyboards, microphones, touch screens, foot pedals, sensors, MIDI devices, and pointing devices such as a mouse or trackball. Output devices include, without limitation, video displays, speakers, refreshable Braille terminal, lights, MIDI devices, and 2-D or 3-D printers.

The other components 550 may include an I/O interface, external serial device ports, and any additional co-processors. For example, a computing system 500 may include an interface (e.g., a universal serial bus (USB) interface) for connecting input devices, output devices, or additional memory devices (e.g., portable flash drive or external media drive). In some implementations, a computing device 500 includes an additional device 550 such as a co-processor, e.g., a math co-processor can assist the processor 520 with high precision or complex calculations.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, i.e., one or more modules of computer program instructions, encoded on one or more computer storage media for execution by, or to control the operation of, a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple optical discs, magnetic disks, or other storage devices). The computer storage medium may be tangible and non-transitory.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an field programmable gate array (“FPGA”) or an application specific integrated circuit (“ASIC”). Such a special purpose circuit may be referred to as a computer processor even if it is not a general-purpose processor. Multiple processors, or a multi-core processor, may be referred to in the singular, as a processor, e.g., when working in concert.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single circuit or software product, or packaged into multiple circuits or software products.

References to “or” may be construed as inclusive so that any terms described using “or” may indicate any of a single, more than one, and all of the described terms. The labels “first,” “second,” “third,” an so forth are not necessarily meant to indicate an ordering and are generally used merely to distinguish between like or similar items or elements.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. A method comprising:
receiving a publication request to enable third-party use of actionable data, the publication request authorized by a first account with a first set of permissions;
recording the first set of permissions in association with the actionable data;
receiving a use request to execute the actionable data, the use request authorized by a second account with a second set of permissions, wherein the second set of permissions is different from the first set of permissions;
determining that a unified set of permissions inclusive of the first set of permissions and the second set of permissions is sufficient to authorize execution of the actionable data; and
authorizing execution of the actionable data responsive to the determination that the unified set of permissions is sufficient.

2. The method of claim 1, wherein one of the first set of permissions or the second set of permissions is insufficient to authorize execution of the actionable data.

3. The method of claim 1, comprising:
receiving the actionable data from a third account with a third set of permissions;
identifying a sub-set of the third set of permissions sufficient to authorize execution of the actionable data; and
recording the sub-set of the third set of permissions in association with the actionable data, wherein the unified set of permissions is inclusive of the recorded sub-set of the third set of permissions.

4. The method of claim 1, comprising:
receiving the actionable data from a third account with a third set of permissions;
wherein the unified set of permissions is inclusive of the third set of permissions.

5. The method of claim 4, wherein the third set of permissions is insufficient to authorize execution of the actionable data.

6. The method of claim 1, wherein the actionable data is a custom deployment template that includes configuration information for a plurality of resources in one or more computing clouds.

7. The method of claim 6, wherein execution of the actionable data includes configuring at least one resource in the plurality of resources based on the configuration information, and wherein configuring the at least one resource requires a sufficient authorization satisfied by the unified set of permissions.

8. The method of claim 6, comprising issuing commands to at least one computing cloud interface based on the configuration information using a credential associated with a source account.

9. The method of claim 8, comprising receiving the actionable data from a third account, wherein the source account is one of the first account or the third account.

10. A system comprising:
a data storage device comprising computer-readable memory configured to store permission information in association with actionable data information;
a computing device comprising computer-readable memory configured to store computer-executable instructions and a processor configured to execute the stored instructions, wherein the instructions, when executed, cause the processor to:
receive a publication request to enable third-party use of actionable data, the publication request authorized by a first account with a first set of permissions;
record, in the data storage device, the first set of permissions in association with the actionable data;
receive a use request to execute the actionable data, the use request authorized by a second account with a second set of permissions, wherein the second set of permissions is different from the first set of permissions;
determine that a unified set of permissions inclusive of the first set of permissions and the second set of permissions is sufficient to authorize execution of the actionable data; and
authorize execution of the actionable data responsive to the determination that the unified set of permissions is sufficient.

11. The system of claim 10, wherein one of the first set of permissions or the second set of permissions is insufficient to authorize execution of the actionable data.

12. The system of claim 10, wherein the instructions, when executed, further cause the processor to:
receive the actionable data from a third account with a third set of permissions;
identify a sub-set of the third set of permissions sufficient to authorize execution of the actionable data; and
record, in the data storage device, the sub-set of the third set of permissions in association with the actionable data;
wherein the unified set of permissions is inclusive of the recorded sub-set of the third set of permissions.

13. The system of claim 10, wherein the instructions, when executed, further cause the processor to:
receive the actionable data from a third account with a third set of permissions;
wherein the third set of permissions is insufficient to authorize execution of the actionable data, and wherein the unified set of permissions is inclusive of the third set of permissions.

14. The system of claim 10, wherein the actionable data is a custom deployment template that includes configuration information for a plurality of resources in one or more computing clouds.

15. The system of claim 14, wherein execution of the actionable data includes configuring at least one resource in the plurality of resources based on the configuration information, and wherein configuring the at least one resource requires a sufficient authorization satisfied by the unified set of permissions.

16. The system of claim 14, wherein the instructions, when executed, further cause the processor to issue commands to at least one computing-cloud interface based on the configuration information using a credential associated with a source account.

17. The system of claim 16, wherein the instructions, when executed, further cause the processor to receive the actionable data from a third account, wherein the source account is one of the first account or the third account.

18. A method comprising:
receiving, from a first requestor, a dissemination request to disseminate a custom deployment template, wherein the custom deployment template includes instructions for configuring a plurality of resources in one or more computing clouds, and wherein configuring at least one resource in the plurality of resources requires a sufficient authorization;
recording, in association with the custom deployment template, authorization information indicating that the first requestor has the sufficient authorization;
receiving, from a second requestor, a launch request to launch the custom deployment template;
determining that the launch request is authorized based on the authorization information recorded in association with the custom deployment template; and
executing the launch request responsive to the determination, wherein executing the launch request causes configuration of the at least one resource.

19. The method of claim 18, comprising determining that the second requestor lacks sufficient authorization to instantiate the at least one resource, and temporarily granting the second requestor the sufficient authorization based on the recorded authorization information.

20. The method of claim 18, wherein the dissemination request is received prior to, and the launch request is received subsequent to, revocation of the sufficient authorization from the first requestor.

21. The method of claim 18, wherein configuring the at least one resource includes one or more of: provisioning the at least one resource, instantiating the at least one resource, modifying a parameter of the at least one resource, and terminating the at least one resource.
